(19) United States
(12) Patent Application Publication
(10) Pub. No.: US 2022/0081954 A1
(43) Pub. Date: Mar. 17, 2022

(54) DOOR ACTUATOR

(71) Applicant: International Truck Intellectual Property Company, LLC, Lisle, IL (US)

(72) Inventors: SARA MARIE DELLORTO, Oak Forest, IL (US); PETER WONG, Naperville, IL (US)

(73) Assignee: International Truck Intellectual Property Company, LLC, Lisle, IL (US)

(21) Appl. No.: 17/018,697

(22) Filed: Sep. 11, 2020

(51) Int. Cl. E05F 17/00; E05F 15/50; E05F 15/60; E05B 77/48; E05B 83/36

(52) U.S. Cl. CPC E05F 17/004; E05F 15/50; E05F 15/60; E05B 77/48; E05Y 2900/506; E05Y 2201/434; E05Y 2201/448; E05Y 2400/32; E05B 83/36

(57) ABSTRACT

An apparatus for actuating a door on a vehicle, the door including a first panel and a second panel both movable between an open position and a completely closed position. A first motor is operatively connected with the first pane for moving the first panel and a second motor operatively connected with the second panel for moving the second panel. A first striker/latch assembly is disposed adjacent the first panel, and a second striker/latch assembly disposed adjacent the second panel. A computer is electrically connected with the first motor, the second motor, the first striker/latch assembly and the second striker/latch assembly.

### BACKGROUND

This disclosure relates generally to an apparatus and a method for actuating a door on a vehicle and a method for substantially continuously monitoring condition of the door. More specifically, this disclosure relates to an apparatus and a method for actuating a service door on a bus and a method for substantially continuously monitoring condition of the service door.

A bus, such as a school bus and the like, includes a service door through which an occupant of the bus passes, i.e. an occupant enters or exits the bus. Accordingly, the service door moves between an open position and a completely closed position. Currently, it is possible that the service door may move towards the open position unintentionally, such as when the school bus is moving. An occupant of the bus may suffer injury if the service door moves towards the open position unintentionally or if the service door is not completely closed. Thus, it is desirable to have an apparatus and a method for reducing likelihood of a bus service door moving towards the open position unintentionally or not having the service door completely closed. Further, it is desirable to have an apparatus and a method for maintaining a bus service door in a closed position. Additionally, it is desirable to have a method for substantially continuously monitoring condition of the bus service door.

### SUMMARY

This disclosure relates to a vehicle door actuating apparatus and method. One embodiment provides an apparatus for actuating a door on a vehicle. The door including a first panel and a second panel disposed adjacent a port on the vehicle. The first panel is movable between an open position where an occupant of the vehicle can move through the port and a completely closed position where the occupant of the vehicle cannot move through the port on the vehicle. The second panel is movable between an open position where an occupant of the vehicle can move through the port and a completely closed position where the occupant of the vehicle cannot move through the port on the vehicle. A first motor is operatively connected with the first pane for moving the first panel between an open position and a completely closed position. A second motor is operatively connected with the second panel for moving the second panel between an open position and a completely closed position. A first striker/latch assembly is disposed adjacent the first panel. A second striker/latch assembly is disposed adjacent the second panel. A computer is electrically connected with the first motor, the second motor, the first striker/latch assembly and the second striker/latch assembly.

### DESCRIPTION OF THE DRAWINGS

FIG. 1 is a perspective view of an apparatus for actuating a door on a vehicle; and

FIG. 2 is a matrix comprising one embodiment of logic behind steps for actuating the door of FIG. 1.

### DETAILED DESCRIPTION

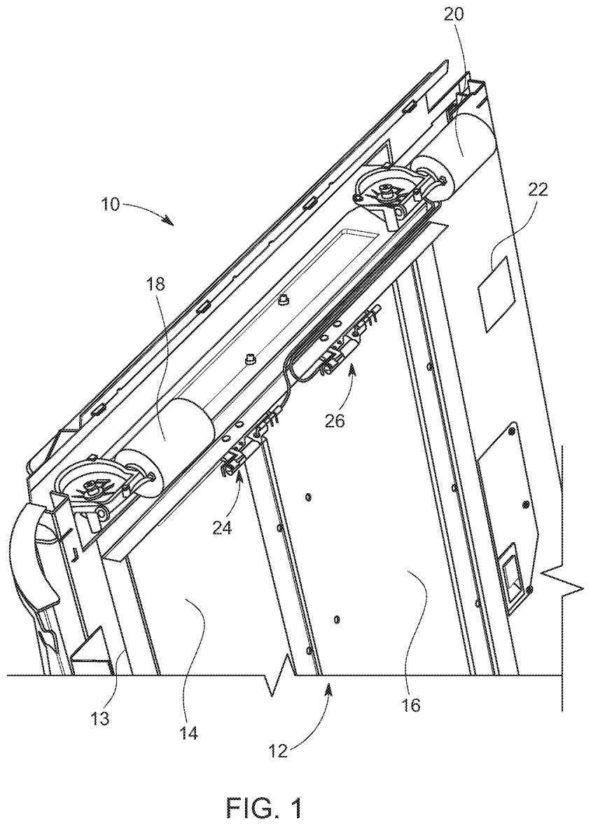

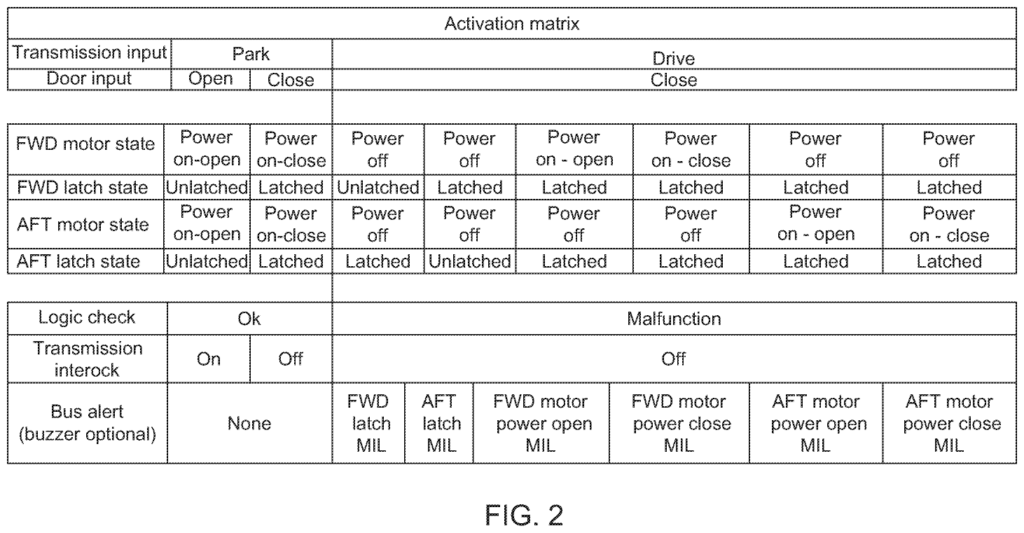

This disclosure relates to an apparatus 10 and a method for actuating a door 12 disposed on a port 13 of a vehicle, such as a bus and the like, and a method for substantially continuously monitoring condition of the door 12. According to an embodiment of the apparatus 10 illustrated in FIG. 1, the door 12 comprises a first panel 14 and a second panel 16. In FIG. 2, the first panel 14 is referenced as FWD door and the second panel 16 is referenced as AFT door. Returning to FIG. 1, in other embodiments, the door 12 may comprise one or more panels. For the sake of clarity, further description is limited to the embodiment where the door 12 comprises the first panel 14 and the second panel 16. Appropriate modifications to this description van be made without departing from concepts disclosed herein.

The first panel 14 and the second panel 16 can move between a completely closed position, as shown in FIG. 1, where on occupant of the vehicle cannot move through the port 13, and an open position where an occupant of the vehicle can move through the port 13, i.e. entering or exiting the vehicle. The first panel 14 is operatively connected with a first motor 18, referenced as FWD motor in FIG. 2, located adjacent an end of the first panel 14. The second panel 16 is operatively connected with a second motor 20, referenced as AFT motor in FIG. 2, located adjacent an end of the second panel 16. At least one of the first motor 18 and the second motor 20 may be substantially similar to an electric motor, a pneumatic actuator such as the (insert make model supplier) and the like. By using both the first motor 18 and the second motor 20, there is no need to include an adjustable linkage to balance interaction between the first panel 14 and the second panel 16. The first motor 18 and the second motor 20 are electrically connected with a computer 22, such as a body controller and the like, located on the vehicle. Status, i.e. the first panel 14 and the second panel 16 moving between the open position and the completely closed position, being in the open position, the completely closed position and the like, of the first motor 18 and the second motor 20 can be communicated periodically, in some embodiments, substantially continuously, to the computer 22. The computer 22 can energize the first motor 18 and the second motor 20 to move the first panel 14 and the second panel 16 between the completely closed position and the open position.

A striker/latch assembly 24, referenced as FWD latch in FIG. 2, is disposed proximate to the first panel 14 and a striker/latch assembly 26, referenced as AFT latch in FIG. 2, is disposed proximate to the second panel 16. The striker/latch assembly 24 and the striker/latch assembly 26 may be substantially similar to a (insert make model supplier). It is to be recognized that the first motor 18 and the second motor 20, viz. movers of the first panel 14 and the second panel 16, are independent of both of the striker/latch assembly 24 and the striker/latch assembly 26. The striker/latch assembly 24 and the striker/latch assembly 26 are both electrically connected with the computer 22. Status of the first motor 18, the second motor 20, striker/latch assembly 24 and the striker/latch assembly 26 can be communicated independently and periodically, in some embodiments, substantially continuously, to the computer 22. The striker/latch assembly 24 is able to retain the first panel 14 in the completely closed position. The striker/latch assembly 26 is able to retain the second panel 16 in the completely closed position. Communication of status, i.e. status indicator, of the first motor 18, the second motor 20, the striker/latch assembly 24 and the strike/latch assembly 26 comprises real-time information about condition of the first panel 14, the second motor 20, the striker/latch assembly 24 and the strike/latch assembly 26.

By providing real-time information about condition of the first panel 14, the second motor 20, the striker/latch assembly 24 and the strike/latch assembly 26, an operator of the vehicle can know if the door 12, i.e. the first panel 14 and the second panel 16, is in the open position or the completely closed position. Armed with this information, the operator can know if the door 12 is open or completely closed. If the door 12 is not in the completely closed position, the computer 22 may reduce ability of the vehicle to move. This can increase safety of an occupant of the vehicle. Also, this information can track condition of the door 12 over time, i.e. number of times the door 12 has moved between the open position and the completely closed position, thereby enabling tracking of wear-and-tear on the door 12.

FIG. 2 comprises a matrix that explains one embodiment of logic behind steps for actuating the door 12. In this embodiment, the computer 22 reduces mobility of the vehicle, e.g. does not allow the vehicle to move, if the computer 22 receives two (2) status indicators that both strike/latch assemblies 24 and 26 are UNLATCHED Requiring two (2) status indicators for the computer 22 to take action provides redundancy in the door actuating system. However, if one status indicator sent to the computer 22 is inconsistent with another status indicator sent to the computer 22, e.g. one status indicator shows that the first door panel 14 is open another status indictor shows that the striker/latch assembly 24 is latched, the computer 22 would generate an error message indicating that maintenance to be performed. Other embodiments of logic behind steps of actuating the door 12 are possible.

What is claimed is:

1. An apparatus for actuating a door on a vehicle, the door including a first panel and a second panel disposed adjacent a port on the vehicle, the first panel being movable between an open position where an occupant of the vehicle can move through the port and a completely closed position where the occupant of the vehicle cannot move through the port on the vehicle, the second panel being movable between an open position where an occupant of the vehicle can move through the port and a completely closed position where the occupant of the vehicle cannot move through the port on the vehicle, the apparatus for actuating the door on the vehicle comprising:
a first motor operatively connected with the first pane for moving the first panel between an open position and a completely closed position;
a second motor operatively connected with the second panel for moving the second panel between an open position and a completely closed position;
a first striker/latch assembly disposed adjacent the first panel;
a second striker/latch assembly disposed adjacent the second panel; and
a computer electrically connected with the first motor, the second motor, the first striker/latch assembly and the second striker/latch assembly.

2. The apparatus of claim 1 wherein the first motor is a pneumatic actuator.

3. The apparatus of claim 1 wherein the second motor is a pneumatic actuator.

5. The apparatus of claim 1 wherein the first motor is an electric motor.

6. The apparatus of claim 1 wherein the second motor is an electric motor.
